(19) United States
(12) Patent Application Publication
(10) Pub. No.: US 2007/0045601 A1
(43) Pub. Date: Mar. 1, 2007

(54) Winch for underwater fish-gathering light and control method therefor

(76) Inventor: Jun-han Rhee, Seoul (KR)

Correspondence Address: LAHIVE & COCKFIELD, LLP, ONE POST OFFICE SQUARE, BOSTON, MA, 02109-2127, US

(21) Appl. No.: 10/555,148

(22) PCT Filed: Apr. 30, 2004
(86) PCT No.: PCT/KR04/01021

§ 371 Date: Nov. 1, 2005

(30) Foreign Application Priority Data
May 1, 2003 (KR) 10-2003-0028008

(51) Int. Cl. B66D 3/00

(52) U.S. Cl. 254/383

(57) ABSTRACT

A winch for use in an underwater fish-gathering light in accordance with the present invention comprises: a driving pulley(110) for winding or unwinding a cable connected to the underwater fish-gathering light; an auxiliary pulley(120) for keeping the cable to stick to the driving pulley; a driving shaft(330) for transmitting driving force to the driving pulley; a driving motor(310) for driving the driving shaft; and a winch controller(350) for controlling the rotation of the driving motor.

### RELATED APPLICATIONS

This application is a 35 U.S.C. 371 national stage filing of International Application No. PCT/KR2004/001021, filed Apr. 30, 2004, which claims priority to Korean Patent Application No. 2003-28008 filed on May 1, 2003 in Republic of Korea. The contents of the aforementioned applications are hereby incorporated by reference.

### TECHNICAL FIELD

This invention relates to a winch for underwater fish-gathering light and its control method. More specifically to, a winch which automatically unwinds or winds a cable connected to an underwater light to gather fish and method for controlling it.

### BACKGROUND ART

Fish may be grouped into two classes according to how they respond to light. One is phototaxis species which go after light and the other is non-phototaxis species which does not. Typical examples of phototaxis class are squid, anchovy, mackerel, horse mackerel, saury, scabbard fish, eel and sardine. Therefore, a fish-gathering light is used to catch these kind of fish.

The fish-gathering light is an equipment used to gather fish by using light. There are two kinds of fish-gathering lights; one used on the water surface and the other one used underwater. In the case of water surface fish-gathering light, many illuminators are used so the light from the surface can reach deep into the sea. To make this possible, a power supply with a large capacity is required. But if the underwater fish-gathering light is used, the number of lights can be reduced, which is more efficient.

For these reasons, recently underwater fish-gathering light is used to gather phototaxis fish. To use the underwater fish-gathering light, waterproof fish-gathering light and waterproof power supply and at the same time cable to pull the underwater fish-gathering light are needed. Ordinarily, there is a power supply line inside the cable connected to the fish-gathering light. The cable is covered with wire. On the other hand, to pull or release the underwater fish-gathering light, a winch is used to wind or unwind the cable connected to the light.

But, a conventional winch or a underwater fish-gathering light has many problems.

In the past, the winch was simply used to connect the pulley used to wind or unwind the cable around the axis of the driving motor. The operator had to wind or unwind the winch manually which was very inconvenient. Also, the operator had to check the length of the cable released into the water to figure out the approximate depth of the underwater fish-gathering light in the sea. When the underwater fish-gathering light is submerged right below the fishing boat then no problem arises. But when the light drifts away by the current then it becomes difficult to check the depth of the light. While unwinding or winding the cable, a part of the cable can get twisted or folded, which makes it hard for the cable to pass through the pulley. When this happens the driving motor gets overloaded which could damage the cable.

Since, the fish-gathering light is positioned underwater, it is hard for the operator to know if the light is damaged. In the end, the operator would not be able to accomplish the allocated work that should be done. In addition, since the operator cannot make out the volume of fish gathered, it would be hard to work efficiently.

In the past there were other problems beside the ones mentioned above when using the winch and the underwater fish-gathering light. For example, the usual operating depth is 30 to 50 meters deep but target fish such as squids live below 100 meters deep in the sea. So the target fish had to be lured to the operating depth. But when using the conventional underwater fish-gathering light the operator simply submerged the light into the sea and waited until the target fish gathered. So the operator could not actively lure the fish to the place where the fishing equipment was positioned.

Some winches for automated underwater fish-gathering light have been invented in the past. They were not fully automated and still had all the problems mentioned above. The operating method of the winches were very complicated so it was hard for the operators to get familiar with the device.

Therefore, in using ocean observation equipments to measure the temperature of the water per depth or the salt content or the speed of the current, a device to maintain the depth of the equipment in the sea has been required.

### DISCLOSURE OF THE INVENTION

To solve the problems mentioned above, the present invention provides a winch for a underwater fish-gathering light equipped with a sensor to detect the state of the operating winch and a controlling system to control the operation of a driving motor by processing input signals. It is also provided a winch controlling method.

The present invention also provides a winch for underwater fish-gathering light which checks and indicates the depth of the underwater equipment and automatically compensate the depth when the operator sets the target depth.

Accordinq to an aspect of the present invention, there is provided a winch for winding and unwinding a cable connected to an underwater device, comprising: a driving pulley(110) driven so as to wind or unwind the cable; an auxiliary pulley(120) for assisting the cable to adhere to the driving pulley(110); a driving axis(330) for transmitting driving force to the driving pulley(110); a driving motor(310) for driving the driving axis(330); and a winch control unit(350) for controlling revolution of the driving motor(310).

According to anotheraspect of the present invention, there is provided a method for controlling operations of a winch for winding and unwinding a cable connected to an underwater device, comprising the steps of: (a) determining a control mode of the winch; (b) setting operating conditions of the winch through input unit when an automatic mode is selected in step (a), herein the operating conditions include any one of operation mode of the winch, target depth and time needed for gathering of underwater equipment; (c) comparing current depth of the underwater equipment with the target depth; and (d) winding the cable if the current depth is lower than the target depth; unwinding the cable if the current depth is higher than the target depth.

### BRIEF DESCRIPTION OF THE DRAWINGS

FIG. 1 is a perspective view of the winch after a desirable operation example of the invention;

FIG. 2a is a front view of the winch in accordance with the present invention;

FIG. 2b is a side view of the winch in accordance with the present invention;

FIG. 2c is a plane view of the winch in accordance with the present invention;

FIG. 3 is a view of the interior composition of the winch in accordance with the present invention;

FIG. 4 is a view of the winch with spring and various sensors installed in accordance with the present invention;

FIG. 5 shows an operation state of the winch in accordance with the present invention;

FIG. 6 shows an underwater fish-gathering light socket connected to the winch in accordance with the present invention;

FIG. 7 shows an outline of the controlling system of the winch in accordance with the present invention; and

FIG. 8 is a flowchart which shows the controlling method of the winch in accordance with the present invention.

### BEST MODE FOR CARRYING OUT THE INVENTION

Reference will now be made in detail to the preferred embodiments of the present invention. The same reference numerals are used to designate the same elements as those shown in other drawings. In the following description of the present invention, a detailed description of known configurations and functions incorporated herein will be omitted when it may make the object matter of the present invention rather unclear.

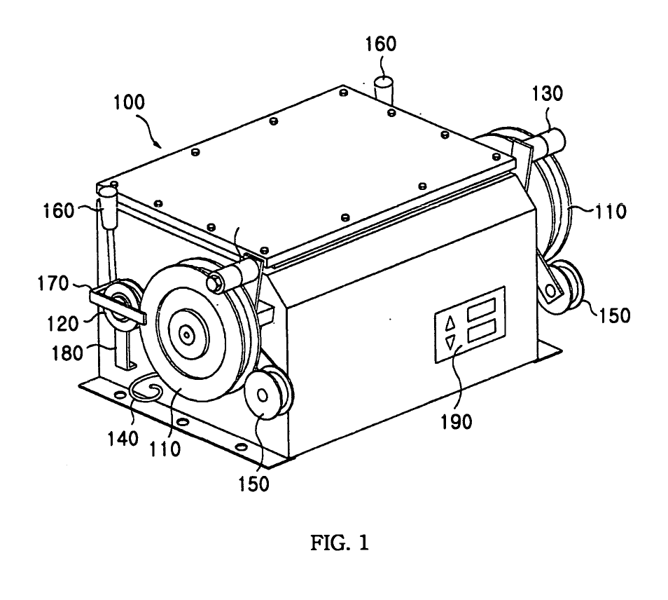

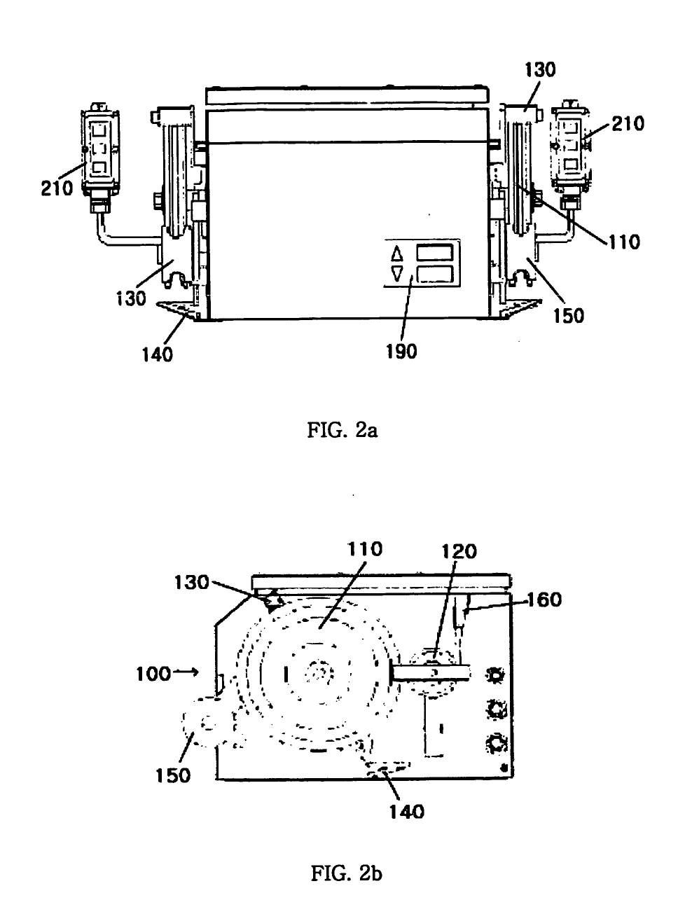

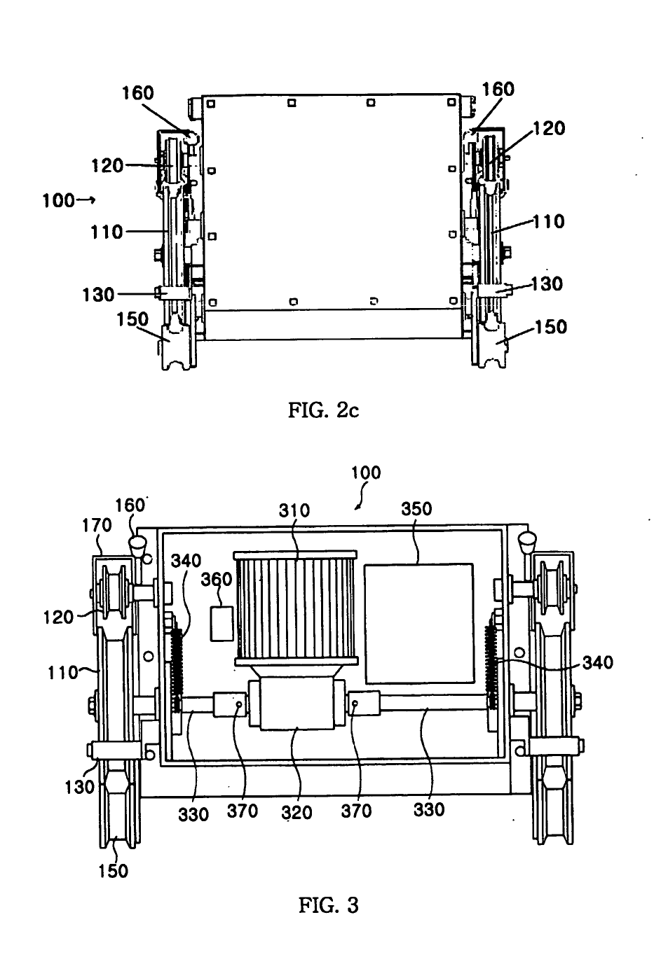

FIG. 1 is a perspective view of the winch 100 in accordance with the present invention. FIG. 2a is a front view, FIG. 2b the side view and FIG. 2c the plane view of the winch 100 in accordance with the present invention.

A driving pulley 110 connected to a driving axis 330 of FIG. 3 is installed on the outside of the winch 100. The driving pulley 110 receives the driving force from the driving axis 330 and winds or unwinds the cable 102 wound on the driving pulley 110. A auxiliary pulley 120 which contacts with the outer surface of the driving pulley 110 is installed on the side of the driving pulley 110. The auxiliary pulley 120 makes the cable 102 adhere closely to the outer surface of the driving pulley 110 when the driving pulley winds or unwinds the cable 102. That is, the cable 102 comes between the driving pulley 110 and the auxiliary pulley 120 which will be described later. The auxiliary pulley 120 receives force in the direction of the spring installed inside or outside of the auxiliary pulley 120 and makes the cable 102 adhere closely to the driving pulley 110.

A guide roller 130 is installed on the upper part of the driving pulley 110 to prevent the cable from escaping when it is wound or unwound along the outside surface of the driving pulley 110. On the other hand, a guide pulley 150 is installed on the lower front part of the driving pulley 110. The guide pulley 150 supports the removal of the cable 102 when it is wound or unwound by the driving pulley 110.

A twist detection device 140 is installed on the lower part of the driving pulley 110. If a part of the cable 102 get twisted then the twist detection device 140 detects the twisted part.

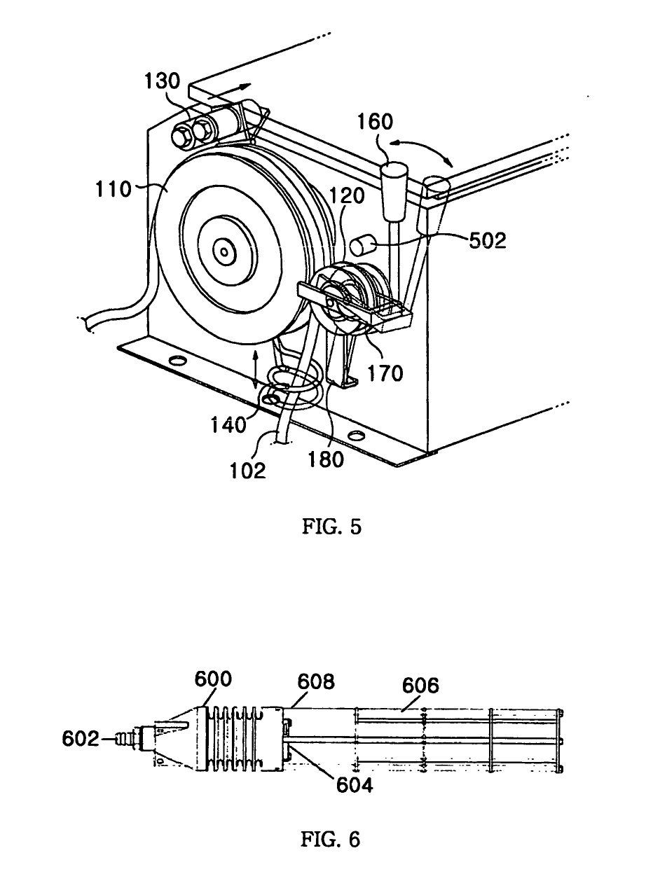

The auxiliary pulley 120 is installed inside the auxiliary pulley housing 170. The auxiliary pulley housing 170 is connected to the auxiliary pulley adjustment lever 160 and the auxiliary pulley support 180. The auxiliary pulley adjustment lever 160, the auxiliary pulley housing 170 and the auxiliary pulley support are made to move in a body and the auxiliary pulley support rotates around where the auxiliary pulley support 180 is installed on the winch 100. These movements of the auxiliary pulley 120 are described in detail with the reference to FIG. 5.

The operation of the winch 100 of the invention is controlled through the use of the operation panel 190 on the winch 100. A remote controller 210 as in FIG. 2a may also be used.

As shown in FIG. 1 and in FIG. 2a or in FIG. 2c, the winch 100 of the present invention is equipped with a cable winch device including a driving pulley 110 and a auxiliary pulley 120 on each side but it is not necessary for the winch 100 to have the cable winch device on both sides. It could be equipped with the cable winch device only on one side.

FIG. 3 shows the composition of the winch 100.

Inside the winch 100, there are included a driving motor 310 and a gear box 320 which is used to transfer the driving force of the driving motor 310 to the driving axis 330 on both sides. A bevel gear is installed inside the gear box 320. The gear box 320 can transfer the driving force of the driving motor 310 to the driving axis 330 on both sides or on one side according to the control of the winch control unit 350.

When only one cable winch device is installed on the winch 100, the driving motor 310 and the driving axis 330 can be connected directly. Alternatively, it is possible to install two driving motors 310 inside the winch 100 and connect to each driving axis on both sides.

A load detection sensor 370 is installed where the gear box 320 and the driving axis 330 are connected. The load detection sensor 370 is a sensor which detects the load on the driving pulley 110 connected to the driving axis 330. The signals detected from the load detection sensor 370 are sent to the winch control unit 350 and the winch control unit 350 controls the driving motor according to the signals received. That is, if the driving pulley 110 is overloaded, the output of the driving motor 310 is increased; on the other hand, if the driving pulley 110 is underloaded, the output is decreased. If the load is greater than the regular output, the operation of the driving motor 310 is stopped to prevent the driving motor 310 from getting damaged.

A motor brake 360 is installed to stop the driving motor 310 when it is overloaded or an emergency happens. The motor brake 360 receives signals from the winch control unit 360 at emergency and stops the driving motor 310. The hysteresis brake can be used as the method for stopping the driving motor 310 at emergency.

A winch control unit 350 which controls the operation of the driving motor 310 is installed inside the winch 100. The winch control unit 350 controls the operation of the winch based on the values input from the operation panel 190 or the remote controller 210 and from the sensors installed inside the winch 100 and sensors installed on the underwater fish-gathering light.

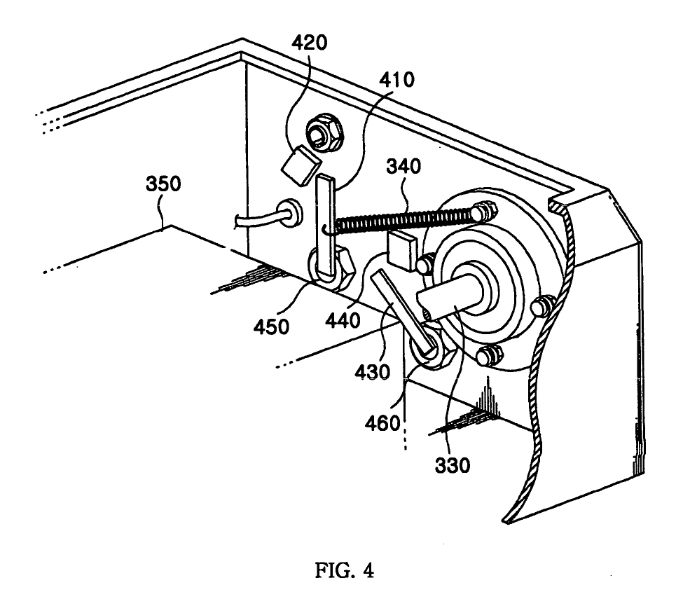

As shown in FIG. 3, there is a spring 340 inside the winch 100 which makes the auxiliary pulley to rotate. The detailed functions of the spring 340 are described with the reference to FIG. 4.

FIG. 4 is the view of the winch 100 with spring and various sensors installed after a desirable operation example of the invention. FIG. 5 shows the operation state of the winch 100 in accordance with the present invention.

FIGS. 4 and 5 show the right side of FIG. 3 seen from the inside and the outside of the winch 100. As in FIG. 4, the one end of the spring 340 is fixed to the case of the winch 100 and the other end of the spring is connected to the spring connection part 340. The spring connection part 410 is joined with the auxiliary pulley support 180 shown on FIG. 5 through a bush 450 installed on the case of the winch 100. The spring connection part 410 and the auxiliary pulley support 180 are joined together to move in a body. When the auxiliary pulley adjustment lever is pulled, the spring connection part 410 also moves accordingly. As in FIG. 5, if the auxiliary pulley adjustment lever 160 is pulled rightward, the spring connection part 410 moves leftward as in FIG. 4 and elongates the spring 340. Therefore, by pulling the auxiliary pulley adjustment lever 160 to space the auxiliary pulley 120 from the driving pulley 110, positioning the cable 102 between the driving pulley 110 and the auxiliary pulley 120 and releasing the auxiliary pulley adjustment lever 160, the auxiliary pulley 120 adheres closely in the direction of the driving pulley 110, assisted by the force of restitution of the spring 340.

As in the preferred embodiment of the present invention, the spring 340 is installed inside the winch 100. However in order to make the auxiliary pulley 120 receive force in the direction of the driving pulley 110, another spring can be employed outside the winch 100 or the spring 340 can be replaced with one installed outside the winch 100.

A first proximity sensor 420 is installed near the spring connection part 410 on the winch 100 case. If the cable 102 moves in the direction of the extension of the driving axis 330 due to the current of the sea water, that is, perpendicular to the outer surface of the driving pulley 120 which is slightly tilted, then the auxiliary pulley 120 and the auxiliary pulley housing 170 combined with the auxiliary pulley 120 and the auxiliary pulley support 180 move together. In this case, the spring connection part 410 moves forward and backward on the surface of the winch 100 case because it is connected through the auxiliary pulley support 180 and the bush 450. Since the first proximity sensor 420 can detect the distance between the spring connection part 410 and the winch 100, it can measure approximately how much the cable 102 has been pushed away by the current.

A twist detection part 430 is installed in the winch 100. The twist detection part 430 is combined through the twist detection device 140 and the bush 460. The twist detection part 430 moves together with the twist detection device 140. The cable 102 passes through the ring shaped twist detection device 140 to be connected to the driving pulley 110. Therefore when the cable 102 is twisted, it would not be able to pass through the twist detection device 140. In this case as in FIG. 5, the twist detection device 140 moves up and down according to the position of the twist in the cable 102. The twist detection part 430 also rotates rightward or leftward around the part combined with the bush 460 since it is connected to the twist detection device 140. The secondary proximity sensor 440 detects the movement of the twist detection part 460 connected with the twist detection device 140 to determine whether the cable 102 is twisted.

If the twist of the cable 102 has been detected, the winch control unit 350 rotates the driving motor 310 forward and backward repeatedly until the cable 102 gets untwisted.

FIG. 5 is referenced to explain the driving method for winding or unwinding of the cable 102.

The cable 102 passes through the ring shaped twist detection device 140 and is installed along the groove formed on the outside surface of the driving pulley 110 when the driving pulley 110 gear into the auxiliary pulley 120. The auxiliary pulley 120 will be installed on the driving pulley 110 by the spring 340 at the rightward movement of the auxiliary pulley adjustment lever 160 as shown in FIG. 5 to obtain space to position the cable 102 on the outside surface of the driving pulley 110 and subsequent release of the auxiliary pulley adjustment lever 160. Since the cable 102 moves while adhering closely to the driving pulley 110 and the auxiliary pulley 120, it not only definitely receives driving force from the driving pulley 110 but also is prevented from escaping from the driving pulley 110.

A guide roller 130 installed on the upper part of the driving pulley 110 guides the cable 102 so it may not escape from the groove formed on the outside surface of the driving pulley 110. In the lower part of the guide roller, there is a guide roller part spring(not shown) installed to remove the pushing strength of the guide roller 130. It makes the guide roller 130 to move forward. The guide roller is adjusted according to the thickness of the cable 102. So the cable 102 can be guided efficiently.

Though not shown in FIG. 5, the winch 100 of the present invention can also support the movement of the cable 102 by installing the guide pulley 150 shown in FIG. 1, FIG. 2a or FIG. 2c.

In the mean time, a tachometer 502 for measuring the number of revolutions of the auxiliary pulley 120 is installed on the winch 100 case where the auxiliary pulley 120 is positioned. The values detected by the tachometer 502 are sent to the winch control unit 350. Then the winch control unit 350 calculates the number of revolutions of the auxiliary pulley 120 and the length of the cable 102 submerged into the water from the diameter of the auxiliary pulley 120 and the luring speed of the cable 102. But, the tachometer 502 can be installed to measure the number of revolutions of the driving pulley 110 or the driving motor 310 instead of the auxiliary pulley 120 in the present invention. At this time, the length of the cable 102 submerged into the water and the luring speed of the cable 102 can be calculated by using the number of revolutions and the diameter of the driving pulley 110.

FIG. 6 shows the underwater fish-gathering light socket 600 connected to the winch in accordance with the present invention.

The underwater fish-gathering light socket 600 is equipped with the cable connection part 602 and the underwater fish-gathering light combination part 604. The cable 102 in this invention is covered with wire to pull the underwater fish-gathering light socket 600. Inside the cable 102, there are power supply line for the underwater fish-gathering light(not shown) and communication line like optical cable to connect the winch control unit 350 with sensors or underwater camera installed on the underwater fish-gathering light socket 600.

The underwater fish-gathering light socket 600 is equipped with fish-gathering light protection device 606 to prevent the light from getting damaged. The sensors are installed on the attachment unit 608 of the underwater fish-gathering light socket 600 and are connected to the winch control unit 350 through the communication line inside the cable 102. But to obtain more accurate results, the sensors may be installed on other parts of the light.

Sensors installed on the underwater fish-gathering light socket 600 are a sensor used to detect the current depth of the light like a pressure sensor, a sensor used to detect the volume of fish gathered like a supersonic sensor and a sensor used to detect the salt content like a temperature sensor. An underwater camera may be installed in addition to the underwater fish-gathering light socket 600. These sensors are explained below in more detail.

A CTD(Conductivity, Temperature, Depth) sensor module for use in general ocean exploration can be installed on the underwater fish-gathering light socket 600. When measuring depth alone, a depth sensor can be used. The depth sensor calculates the depth by using the water pressure measured in the hydrostatic pressure equation. The depth sensor plays an important role when gathering the target fish as described below.

The target fish usually live more than 100 meters below the surface of the sea. Therefore, the fish should be lured to the depth where the fishing operation is possible by using the underwater fish-gathering light. For example, squids live more than 100 meters below the surface of the sea. So they should be lured to 30 to 50 meters depth to be captured. In order to keep the squids stay at the depth, the underwater fish-gathering light should also be positioned at that depth. Therefore, the depth sensor detects the depth of the underwater fish-gathering light and makes the winch 100 wind or unwind the cable 102 to adjust the depth of the light.

Besides the CTD sensor and the depth sensor, an proximity sensor for determining the volume of fish gathered may also be installed. The proximity sensor for determining the volume of fish gathered detects the presence of the target fish around the underwater fish-gathering light. If the target fish such as squids gather around the light then the proximity sensor for determining the volume of fish gathered sends a signal to the winch control unit 350. Then the winch control unit 350 indicates that the target fish have gathered on the indication unit so the operator can start capturing.

There are several advantages when an underwater camera is used besides the proximity sensor for determining the volume of fish gathered. Even though the expense increases, the underwater camera installed in addition to the proximity sensor greatly helps determining the volume of fish gathered, and further confirming the kind of fish gathered and the amount through the camera. By using the camera, the condition underwater can be checked. It can also be used for sea farming. That is, divers no longer need to go into the sea to check on the growth and the condition of the farm and to confirm the right time for harvesting.

By installing the ADCP(Acoustic Doppler Current Profiler) on the underwater fish-gathering light socket 600, the speed of the current can be measured to grasp the situation for fishing. The first proximity sensor can detect coarsely how much the cable 102 has been bent when determining the speed of the current on the floor of the sea. But if a sensor like ADCP is used, the underwater condition can be more accurately determined. ADCP is an ocean observation equipment which uses the doppler effect of sound wave to measure the flow of sea water. It can be used to determine the condition underwater to decide whether fishing and the use of underwater fish-gathering light is feasible.

When the winch 100 is used for underwater exploration, the underwater exploration equipment can be installed on the cable 102. Then the winch 100 can control the movement of the underwater exploration equipment to make exploration or investigation efficient.

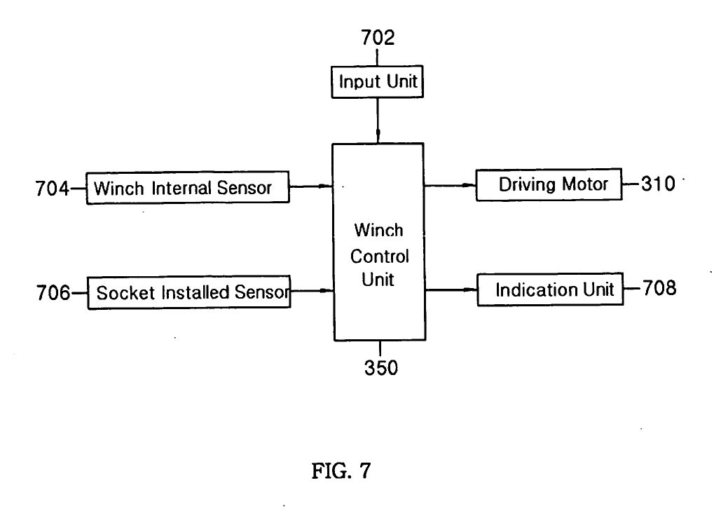

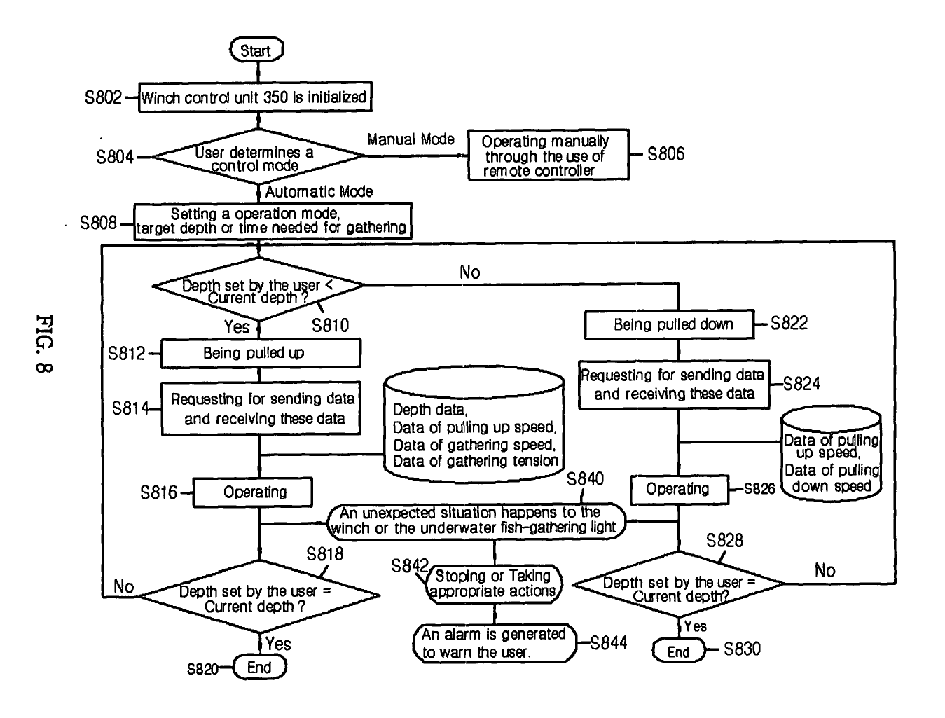

FIG. 7 shows the outline of the controlling system of the winch 100 after a desirable operation example of the invention. That is, the controlling method of the winch control unit 350.

The user input the values of the winch 100 operation mode, the target depth of the underwater equipment, the pulling speed of the underwater equipment or the retention period of the depth set through input unit 702 such as the operation panel 190 or the remote controller 210. The winch control unit 350 processes all kinds of values input from the input unit 702 and signals input from winch internal sensor 704 and socket installed sensor 706 to control the driving motor 310 and to display the operation condition on the indication unit 708.

The winch internal sensor 704 includes the load detection sensor 370, the first proximity sensor 420, the secondary proximity sensor 440 and the tachometer 502. The socket installed sensor 706 includes the water pressure sensor, the CTD sensor, the ADCP sensor and the proximity sensor for determining the volume of fish gathered.

The winch control unit 350 calculates the current depth of the underwater fish-gathering light, the pulling speed of the cable 102 or the operation condition of the winch 100 with the signals input from the sensors mentioned above. Then it controls the direction and the number of revolutions of the driving motor 310. When there are problems to the winch itself or to the underwater fish-gathering light, it indicate the situation and take actions accordingly.

On the other hand, the indication unit 708 displays the current depth of the underwater equipment, the depth of the cable 102 underwater, and the pulling speed. When the proximity sensor for the underwater fish-gathering light is used, the volume of fish gathered can be given. When the underwater camera is installed on the underwater fish-gathering light socket 600 a separate display is needed to show the image caught by the camera.

FIG. 8 is the flowchart which shows the controlling method of the winch after a desirable operation example of the invention.

When the winch 100 is powered on, the winch control unit 350 is initialized and checks whether the winch control unit 350 is operating in order. The sensors and the driving motor 310 are also checked (S802). When there are problems to the parts inside the winch 100 then an error message is displayed.

The user determines a control mode of the winch 100 (S804). When a manual mode is selected, the winch 100 is operated manually through the use of remote controller 210 (S806). At this time, the winch control unit 350 indicates the depth of the equipment underwater, the depth of the cable 102 underwater, the pulling speed of the cable 102 at the indication unit 708 to inform the user of the operation condition of the winch and the condition of the underwater fish-gathering light.

When an automatic mode is selected, the user can set the method for gathering target fish or the retention period of the depth of the underwater fish-gathering light that should be maintained (S808).

The winch control unit 350 runs the winch 100 according to the user's input. The control of the winch 100 is accomplished by controlling the winding or the unwinding process of the cable 102. That is, by controlling the direction and the number of revolutions of the driving motor 310. At this point, the control of the depth of the underwater fish-gathering light becomes critical and most difficult, the reason of which will be described.

Comparison of the current depth of the underwater fish-gathering light with the depth the user has set is performed (S810). If the current depth is lower than the depth set by the user, the cable 102 is wound to pull up the light (S812). If it is higher than the depth set, the cable 102 is unwound to lower the light (S822).

When the underwater fish-gathering light has to be pulled up, the winch control unit 350 requests data such as the depth data with the time needed for gathering fish, the data of pulling up speed, the data of gathering speed, and the data of gathering tension from its own memory. It operates the driving motor 310 after receiving these data to pull up the light (S814, S816). If the input depth and the current depth of the underwater fish-gathering light match each other, the driving motor 310 is stopped to wait for the next procedure (S820).

When the underwater fish-gathering light has to be lowered, the winch control unit 350 operates the driving motor 310 based on the input depth data and the data of lowering speed to lower the light (S822, S824, S826) as it did when the light has been pulled up. If the input depth and the current depth of the underwater fish-gathering light are identical, the driving motor 310 is stopped to wait for the next procedure (S830).

In the mean time, an unexpected situation may happen to the winch 100 or the underwater fish-gathering light while raising or lowering the winch 100. For example, the cable 102 can get twisted or the underwater fish-gathering light can get damaged. Or the driving motor 310 can get overloaded when the underwater fish-gathering light gets caught by an abandoned net. When these situations break out then the winch control unit 350 takes appropriate actions (S840, S842, S844).

When the cable 102 get twisted then the twist detection device 140 and the secondary proximity sensor 440 input signals indicating the situation to the winch control unit 350. At this time, the winch control unit 350 makes the driving motor 310 to revolve forward and backward repeatedly until the cable 102 gets untwisted. When the underwater fish-gathering light gets damaged, the power supply connected to the light is shut down and an alarm is generated. Also, when the underwater fish-gathering light get caught in a net or when it is hard to operate properly due to high speed of the current, an alarm is generated to warn the user. Especially, when the light has been operated at an automatic mode, the mode is cancelled and the light waits for user's actions.

The cable 102 can be arranged on the deck, but it would be convenient to keep the cable 102 in a roll. When you keep the cable 102 in a roll then the cable 102 can be unwound automatically with the driving pulley 110 of the winch 100. But when the cable 102 is wound with the winch 100 then the cable 102 get piled up on the hull. Therefore, it is desirable to use a cable roll which is run by a separate driving motor(not shown).

When employing a separate driving motor for the cable roll, the electric motor connected to the cable roll can be controlled by the winch control unit 350. As described above, the winch control unit 350 detects the number of revolutions of the auxiliary pulley 120 or the driving pulley 120 or the driving motor 310 and make out the transfer speed of the cable 102. By controlling the direction and the number of revolutions of the electric motor installed on the cable roll, the cable 102 need not be taken care of separately.

With the use of echo sounder and GPS(Global Positioning System), the operator can get the accurate depth of the underwater fish-gathering light. The accurate depth of the underwater equipment can be obtained by processing the radiometric correction and the geometric correction based on the sound detection data of the underwater geographical features collected by the echo sounder and the underwater geographical detection data collected by GPS.

Althoug the description of the usage of the winch 100 of the present invention has been limited to the use for the underwater fish-gathering light, the winch 100 can be used for other underwater exploration equipments or equipments with underwater camera installed to check the condition underwater. So the usage of the winch 100 should not be limited to only those described here.

While this invention has been described in connection with what is presently considered to be the most practical and preferred embodiment, it is to be understood that the invention is not limited to the disclosed embodiment and the drawings, but, on the contrary, it is intended to cover various modifications and variations within the spirit and scope of the appended claims.

While this invention has been described in connection with what is presently considered to be the most practical and preferred embodiment, it is to be understood that the invention is not limited to the disclosed embodiment and the drawings, but, on the contrary, it is intended to cover various modifications and variations within the spirit and scope of the appended claim.

### INDUSTRIAL APPLICABILITY

As described above, the winch can automatically wind or unwind cable cascading underwater fish-gathering lights based on the signals received from various sensors installed on the winch and the signals received from various sensors equipped on the underwater fish-gathering light socket. In addition, the user can work efficiently by selecting winch operation modes from the methods used to gather each kind of target fish, the time needed for gathering or the method of underwater exploration stored in the winch control unit.

1. A winch for winding and unwinding a cable connected to an underwater device, comprising:
a driving pulley(110) driven so as to wind or unwind the cable;
an auxiliary pulley(120) for assisting the cable to adhere to the driving pulley(1 10);
a driving axis(330) for transmitting driving force to the driving pulley(110);
a driving motor(310) for driving the driving axis(330); and
a winch control unit(350) for controlling revolution of the driving motor(310).

2. The winch of claim 1, wherein the winch further comprises any one of:
an operation panel(190) for inputting operating conditions of the winch(100) into the winch control unit(350); and
a remote controller(210) for manually controlling the winch.

3. The winch of claim 1, wherein the winch further comprises:
an auxiliary pulley housing(170) for accommodating the auxiliary pulley(120);
an auxiliary pulley support(180), one end thereof assembled to the auxiliary pulley housing(170), the other end thereof rotatably connected to a part of the winch(100); and
an auxiliary pulley adjustment lever(160), assembled to the auxiliary pulley housing(170), for enabling the auxiliary pulley housing(170) and the auxiliary pulley support(180) to smoothly move.

4. The winch of claim 3, wherein the auxiliary pulley support(180) is assembled to a spring connection part(410) installed in the winch through a bush(450) attached to the winch, and one end of the spring connection part(410) is connected to a spring(340) firmly connected to the body of the winch to thereby enable the auxiliary pulley support(180) to receive power to the direction of the driving pulley(110).

5. The winch of claim 1, wherein the winch further comprises:
a tachometer(502) for detecting a number of revolutions of either driving pulley(110) or the auxiliary pulley(120) and sending the number of revolutions to the winch control unit(350).

6. The winch of claim 1, wherein the winch further comprises any one of:
a guide roller(130), one end thereof connected to the body of the winch, for preventing the cable from escaping from a groove of the driving pulley(110); and
a guide pulley(150), one end thereof connected to the body of the winch, for preventing the cable from escaping and assisting the movement of the cable.

7. The winch of claim 1, wherein the winch further comprises any one of:
a twist detection/prevention means including a twist detection device(140) for preventing twist of the cable, a twist prevention part(460) interworking with the twist detection device9l40), and a secondary proximity sensor for transmitting detected twist of the cable to the winch control unit(350); and
a load detection sensor(370) for detecting load of the driving pulley110) and transmitting the load to the winch control unit(350).

8. The winch of claim 7, wherein the winch control unit 350 processes signals input from any one of the secondary proximity sensor 440 and the load detection sensor 370, controls revolution of the driving motor 310 and transmits the signals to indication unit displaying condition of the winch and the underwater device.

9. The winch of claim 1, wherein the underwater device is an underwater fish-gathering light socket 600 including:
a cable connection part 602;
an underwater fish-gathering light combination part 604;
a fish-gathering light protection device 606 for preventing the underwater fish-gathering light from getting damaged; and
an attachment unit 608 for installing any one of sensors sensing ocean environment.

10. The winch of claim 9, wherein the sensors installed on the attachment unit 608 includes a depth sensor for detecting depth by using the water pressure measured.

11. The winch of claim 9, wherein the sensors installed the attachment unit 608 includes a proximity sensor for determining the volume of fish gathered.

12. The winch of claim 9, wherein an underwater camera is installed on the underwater fish-gathering light socket 600.

13. The winch of claim 9, wherein the winch control unit 350 processes signals input from the sensors installed on the attachment unit 608, controls revolution of the driving motor 310 and transmits the signals to indication unit displaying condition of the winch and the underwater fish-gathering light.

14. A method for controlling operations of a winch for winding and unwinding a cable connected to an underwater device, comprising the steps of:
(a) determining a control mode of the winch;
(b) setting operating conditions of the winch through input unit when an automatic mode is selected in step (a), herein the operating conditions include any one of operation mode of the winch, target depth and time needed for gathering of underwater equipment;
(c) comparing current depth of the underwater equipment with the target depth; and
(d) winding the cable if the current depth is lower than the target depth; unwinding the cable if the current depth is higher than the target depth.

15. The method of claim 14, further comprising the steps of:
noticing to an user by indicating situation on an indication unit when there are problems to the winch or to the underwater device.
